(19) United States
(12) Patent Application Publication
(10) Pub. No.: US 2015/0059603 A1
(43) Pub. Date: Mar. 5, 2015

(54) COLLECT PRINTING PRESS

(71) Applicant: KOMORI CORPORATION, TOKYO (JP)

(72) Inventor: Hiroyoshi KAMODA, Tsukuba-shi (JP)

(21) Appl. No.: 14/474,898

(22) Filed: Sep. 2, 2014

(30) Foreign Application Priority Data
Sep. 3, 2013 (JP) 2013-181747

(51) Int. Cl. B41M 3/14; B41F 7/24; B41F 13/18; B41F 13/193; B41F 11/00; B41F 9/02

(52) U.S. Cl. CPC B41M 3/14; B41F 11/00; B41F 9/021; B41F 13/18; B41F 13/193; B41F 7/24
USPC 101/136

(57) ABSTRACT

A collect printing press includes: an impression cylinder configured to hold and transport a sheet; a rubber cylinder being in contact with the impression cylinder and including a blanket mounted thereon; a collecting plate cylinder being in contact with the rubber cylinder and including a plate mounted thereon; a collecting rubber cylinder being in contact with the collecting plate cylinder and including a blanket mounted thereon; multiple partial plate cylinders each being in contact with the collecting rubber cylinder and including a plate mounted thereon; and multiple inking devices configured to feed inks to the partial plate cylinders, respectively. The plate of the collecting plate cylinder is a relief printing plate, and the plate of each of the partial plate cylinders is a lithographic printing plate, and the collect printing press further includes multiple dampening units configured to feed dampening water to the partial plate cylinders, respectively.

### TECHNICAL FIELD

The present invention relates to a collect printing press capable of printing an image line of an image pattern in such a manner as to change the color of the image line.

### BACKGROUND ART

In collect printing presses capable of printing an image line of an image pattern in such a manner as to change the color of the image line, inks of multiple colors at positions different in the axial direction are fed onto partial plate cylinders, each including a relief printing plate mounted thereon, by means of an oscillating roller in an oscillating manner in the axial direction, and then transferred to a collecting plate cylinder via a collecting rubber cylinder. In this way, the color of the image line can be changed in the middle in the axial direction without causing any misalignment at all. Thus, these collect printing presses have been utilized to print banknotes, securities, and like for an anti-counterfeit purpose (see Patent Literature 1 listed below, for example).

### CITATION LIST

### Patent Literature

{Patent Literature 1} Japanese Patent Application Publication No. 2013-086437

### SUMMARY OF INVENTION

### Technical Problem

There has been a strong demand for collect printing presses as described above to be capable of performing higher anti-counterfeit printing.

### Solution to Problem

A collect printing press according to the present invention for solving the above problem provides a collect printing press, including: an impression cylinder configured to hold and transport a sheet; a blanket cylinder being in contact with the impression cylinder and including a blanket mounted thereon; a collecting plate cylinder being in contact with the blanket cylinder and including a plate mounted thereon; a collecting blanket cylinder being in contact with the collecting plate cylinder and including a blanket mounted thereon; multiple partial plate cylinders each being in contact with the collecting blanket cylinder and including a plate mounted thereon; and multiple ink feeding means for feeding inks to the partial plate cylinders, respectively, in which the plate of the collecting plate cylinder is a relief printing plate, the plate of each of the partial plate cylinders is a lithographic printing plate, and the collect printing press further includes multiple water feeding means for feeding dampening water to the partial plate cylinders, respectively.

### Advantageous Effect of Invention

In the collect printing press according to the present invention, the plate of the collecting plate cylinder is a relief printing plate, and the plate of each of the partial plate cylinders is a lithographic printing plate, and the collect printing press includes the multiple water feeding means for feeding dampening water to the partial plate cylinders, respectively. Thus, gradation can be formed on the lithographic printing plate of each partial plate cylinder not only in the axial direction of the partial plate cylinder but in all directions (360°) without limitation by means of the density and size of dots forming the line image on the lithographic printing plate. The gradation is transferred onto the image pattern (convex portions) on the relief printing plate of the collecting plate cylinder. Thus, it is possible to print an image pattern with gradation that changes the color of the image line gradually in given directions among all directions of the sheet. Accordingly, the collect printing press according to the present invention is capable of performing higher anti-counterfeit printing.

### BRIEF DESCRIPTION OF DRAWING

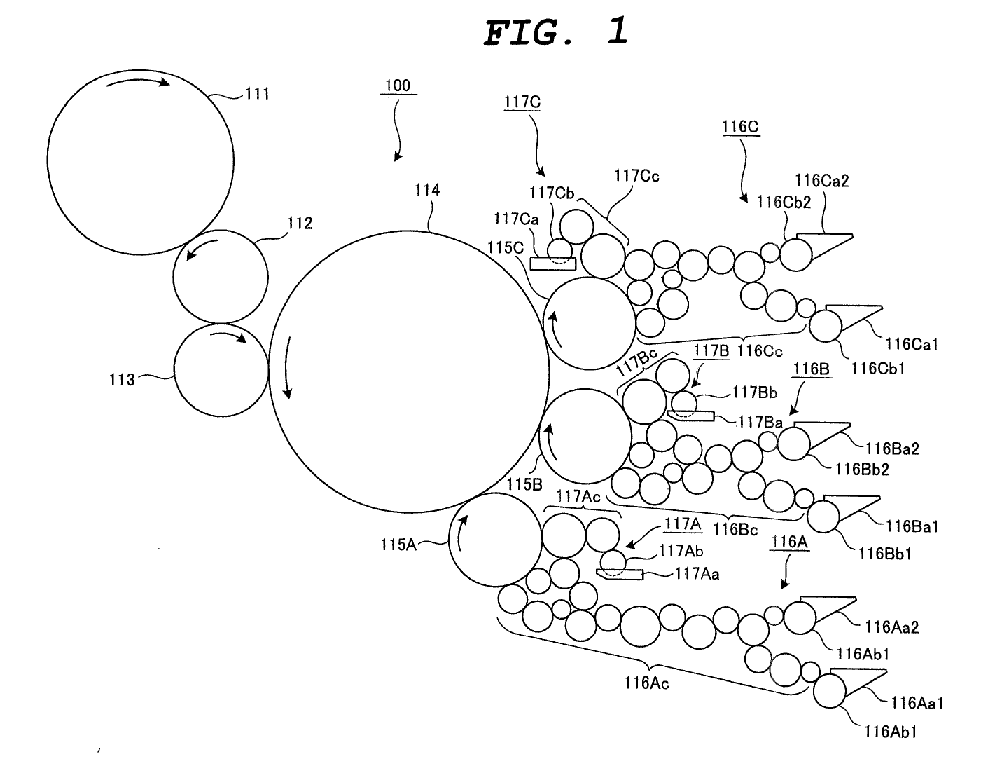

{FIG. 1} FIG. 1 is a schematic structural view of a chief part of a main embodiment of a collect printing press according to the present invention.

### DESCRIPTION OF EMBODIMENT

An embodiment of a collect printing press according to the present invention will be described below with reference to the drawing. However, the present invention is not limited to the embodiment to be described with reference to the drawing.

### Main Embodiment

A main embodiment of the collect printing press according to the present invention will be described with reference to FIG. 1.

As shown in FIG. 1, a rubber cylinder 112 which is a blanket cylinder with a rubber blanket mounted on the outer peripheral surface thereof is in contact with an impression cylinder 111 configured to hold and transport a sheet on the outer peripheral surface thereof. A collecting plate cylinder 113 with a resin relief printing plate mounted on the outer peripheral surface thereof is in contact with the rubber cylinder 112. A collecting rubber cylinder 114 which is a collecting blanket cylinder with a rubber blanket mounted on the outer peripheral surface thereof is in contact with the collecting plate cylinder 113. Multiple (three in this embodiment) partial plate cylinders 115A to 115C each with a lithographic printing plate (Pre-Sensitized plate/PS plate) mounted on the outer peripheral surface thereof are in contact with the collecting rubber cylinder 114 and arranged in the circumferential direction of the collecting rubber cylinder 114.

Inking devices 116A to 116C which are ink feeding means for feeding inks communicate with the partial plate cylinders 115A to 115C, respectively. The inking devices 116A to 116C respectively include: pairs of ink fountains 116Aa1 to 116Ca1, 116Aa2 to 116Ca2 configured to store inks; pairs of fountain rollers 116Ab1 to 116Cb1, 116Ab2 to 116Cb2 configured to draw out the inks from the pairs of ink fountains 116Aa1 to 116Ca1, 116Aa2 to 116Ca2, respectively; and ink roller trains 116Ac to 116Cc configure to feed the inks drawn out by the pairs of fountain rollers 116Ab1 to 116Cb1, 116Ab2 to 116Cb2 onto the partial plate cylinders 115A to 115C, respectively.

Note that the ink fountains 116Aa1 to 116Ca1 store inks on one side in the axial direction of the fountain rollers 116Ab1 to 116Cb1, whereas the ink fountains 116Aa2 to 116Ca2 store inks on the other side in the axial direction of the fountain rollers 116Ab2 to 116Cb2. In this way, each of the inking devices 116A to 116C can feed the corresponding one of the partial plate cylinders 115A to 115C with inks at positions different in the axial direction.

Dampening units 117A to 117C which are water feeding means for feeding dampening water communicate with the outer peripheral surfaces of the partial plate cylinders 115A to 115C at positions downstream of the contact positions with the collecting rubber cylinder 114 in the rotational direction of the partial plate cylinders 115A to 115C but upstream of the contact positions with the ink roller trains 116Ac to 116Cc of the inking devices 116A to 116C in the rotational direction of the partial plate cylinders 115A to 115C, respectively. The dampening units 117A to 117C respectively include: fountain pans 117Aa to 117Ca configured to store dampening water; water fountain rollers 117Ab to 117Cb configured to feed the dampening water inside the fountain pans 117Aa to 117Ca, respectively; and water roller trains 117Ac to 117Cc configured to feed the dampening water fed from the water fountain rollers 117Ab to 117Cb onto the partial plate cylinders 115A to 115C, respectively.

In a collect printing press 100 according to this embodiment as described above, the dampening units 117A to 117C feed the dampening water inside the fountain pans 117Aa to 117Ca onto the water fountain rollers 117Ab to 117Cb, and then feed the dampening water via the water roller trains 117Ac to 117Cc onto the plates (PS plates) of the partial plate cylinders 115A to 115C, respectively. Also, the inking devices 116A to 116C draw out the inks inside the pair of ink fountains 116Aa1 to 116Ca1, 116Aa2 to 116Ca2 with the fountain rollers 116Ab1 to 116Cb1, 116Ab2 to 116Cb2, and feed the inks to the plates (PS plates) of the partial plate cylinders 115A to 115C via the roller trains 116Ac to 116Cc, respectively. As result, a water film is formed on non-image-line areas of the plate (PS plate) of each of the partial plate cylinders 115A to 115C, and ink films are formed on image-line areas of the plate. The inks are then transferred onto the blanket of the collecting rubber cylinder 114 into image patterns corresponding to the image-line areas of the plates (PS plates) of the partial plate cylinders 115A to 115C. Thereafter, the inks transferred from the partial plate cylinders 115A to 115C are transferred collectively onto the relief printing plate of the collecting plate cylinder 113 and then transferred via the rubber cylinder 112 onto a sheet held on the outer peripheral surface of the impression cylinder 111. As a result, collect printing is done on the sheet.

Here, since the partial plate cylinders 115A to 115C have lithographic printing plates (PS plates) mounted thereon, image lines with gradation in the axial direction and in the circumferential direction of the partial plate cylinders 115A to 115C, i.e. in all directions (360°) can be formed on the plates (PS plates) by means of the density and size of dots forming the line images. Thus, the inks expressing the gradation by means of the density and size of dots are transferred on the blanket of the collecting rubber cylinder 114, copied (transferred) onto the convex portions (image patterns) of the relief printing plate of the collecting plate cylinder 113, and then transferred via the blanket of the rubber cylinder 112 onto a sheet. As a result, the line images (image patterns) with the gradation in both the widthwise direction and the lengthwise direction of the sheet, i.e. in all directions (given directions) are printed.

Thus, with the collect printing press 100 according to this embodiment, it is possible to gradually change the color of an image line (image pattern) in all directions (360°) of a sheet without limitation, instead of using axial oscillation of an oscillating roller to change the color of the image line in the widthwise direction of the sheet by the amount of the oscillation of the oscillating roller, as has been done in conventional practices.

Accordingly, the collect printing press 100 according to this embodiment is capable of performing higher anti-counterfeit printing.

### INDUSTRIAL APPLICABILITY

Since being capable of performing higher anti-counterfeit printing, the collect printing press according to the present invention can be utilized highly beneficially in the printing industry and other similar industries.

### REFERENCE SIGNS LIST

100 COLLECT PRINTING PRESS

111 IMPRESSION CYLINDER

112 RUBBER CYLINDER

113 COLLECTING PLATE CYLINDER

114 COLLECTING RUBBER CYLINDER

115A to 115C PARTIAL PLATE CYLINDER

116A to 116C INKING DEVICE

116Aa1 to 116Ca1, 116Aa2 to 116Ca2 INK FOUNTAIN

116Ab1 to 116Cb1, 116Ab2 to 116Cb2 FOUNTAIN ROLLER

116Ac to 116Cc ROLLER TRAIN

117A to 117C DAMPENING UNIT

117Aa to 117Ca FOUNTAIN PAN

117Ab to 117Cb WATER FOUNTAIN ROLLER

117Ac to 117Cc WATER ROLLER TRAIN

1. A collect printing press, comprising:
an impression cylinder configured to hold and transport a sheet;
a blanket cylinder being in contact with the impression cylinder and including a blanket mounted thereon;
a collecting plate cylinder being in contact with the blanket cylinder and including a plate mounted thereon;
a collecting blanket cylinder being in contact with the collecting plate cylinder and including a blanket mounted thereon;
a plurality of partial plate cylinders each being in contact with the collecting blanket cylinder and including a plate mounted thereon; and
a plurality of ink feeding means for feeding inks to the partial plate cylinders, respectively,
wherein the plate of the collecting plate cylinder is a relief printing plate,
the plate of each of the partial plate cylinders is a lithographic printing plate, and
the collect printing press further comprises a plurality of water feeding means for feeding dampening water to the partial plate cylinders, respectively.
